(19) United States
(12) Patent Application Publication
(10) Pub. No.: US 2008/0102677 A1
(43) Pub. Date: May 1, 2008

(54) Pull-out device

(75) Inventors: Hideo Sakamoto, Tokyo (JP); Yoichi Hirasawa, Tokyo (JP); Shawn Turner, Tokyo (JP)

Correspondence Address: BUCHANAN, INGERSOLL & ROONEY PC, POST OFFICE BOX 1404, ALEXANDRIA, VA, 22313-1404, US

(73) Assignee: HIRATA CORPORATION, Tokyo (JP)

(21) Appl. No.: 12/004,031

(22) Filed: Dec. 20, 2007

Related U.S. Application Data
(63) Continuation of application No. PCT/JP2005/011455, filed on Jun. 22, 2005.

(51) Int. Cl. H01R 11/22

(52) U.S. Cl. 439/266

(57) ABSTRACT

This invention provides a pull-out device for pulling out a connector from an apparatus to which the connector is connected, including a pulling member having one end attached to the connector and the other end with a locking portion, a locking unit arranged to face the connector and to which the locking portion is locked, and a moving unit arranged to move the locking unit and the apparatus relative to each other so as to separate from each other in a pull-out direction of the connector, thereby causing the pulling member to generate tension that pulls out the connector, wherein the locking unit locks with the locking portion such that, as the tension is generated, the locking portion is freely movable within a plane substantially perpendicular to the pull-out direction.

### TECHNICAL FIELD

The present invention relates to a technique which facilitates a post-process after-testing of various types of apparatuses such as an electrical appliance and, more particularly, to a pull-out device which pulls out a connector such as an input/output terminal from a tested apparatus.

### BACKGROUND ART

Various types of apparatuses such as an electrical appliance undergo tests such as an operational check before shipping. In such a test, in order to electrically connect a tester to the apparatus, a connector is mounted on the apparatus. When testing has finished, an operation to remove the connector is required. For example, the following techniques are available to facilitate such post-processing.

When testing the conductivity of an input/output terminal of an electrical appliance such as a television, a large force is necessary to insert and pull out a jig. In view of this problem, Japanese Utility Model Laid-Open No. 5-17565 discloses an inspection jig which mechanically aids the operation of inserting a contact terminal into the input/output terminal and bringing the contact terminal into contact with the input/output terminal, thereby reducing the amount of work required to perform the test.

Japanese Patent Laid-Open No. 2001-319753 discloses a connector pull-out tool that disengages a receptacle connector and plug connector fitted and held by a lock portion. The lock portion is a hook-like member provided to the receptacle connector or plug connector. When pressing the lock portion inward in a direction perpendicular to the direction of insertion of the receptacle connector or plug connector, the fitted receptacle connector and plug connector can be disengaged. The connector pull-out tool disclosed in Japanese Patent Laid-Open No. 2001-319753 has a U-shaped section. By inserting the connector pull-out tool such that it covers the receptacle or plug connector and having one of the facing plate bodies press the lock portion, the fitting held by the lock portion can be disengaged easily.

Japanese Patent Laid-Open No. 7-97004 discloses a warehouse in which a plurality of batteries is accommodated on trays, and the trays are placed on X racks by a crane and stored. Each rack of the warehouse is provided with a measurement unit arranged to measure the charge voltage or the like of the battery. During storage, the measurement unit measures the charge voltage or the like to inspect the battery. Therefore, the space for inspection and the space for storage need not be provided separately, reducing the required space. The battery need not be retrieved from and replaced to the warehouse for inspection, facilitating management. In the warehouse, electrodes for voltage measurement are connected to battery electrodes in the vertical direction of the tray. This allows inspection of all the batteries accommodated on the tray simultaneously, thereby shortening the lead time.

As in the inspection jig described in Japanese Utility Model Laid-Open No. 5-17565, however, even with the inspection jig that mechanically aids the operation of inserting the contact terminal in the input/output terminal and bringing the contact terminal into contact with the input/output terminal, the input/output terminal must be pulled out manually for each connector. The connector that can be inspected by using this inspection jig is limited to those having a predetermined shape.

As in the connector pull-out tool described in Japanese Patent Laid-Open No. 2001-319753, even with a connector pull-out tool that can easily disengage the connectors held by the lock portion, the connector pull-out tool must be set and disconnected manually for each connector. The connector that can be pulled out by using this connector pull-out tool is limited to those having a predetermined shape.

The warehouse described in Japanese Patent Laid-Open No. 7-97004 is specialized for battery inspection and does not cope with all inspections of apparatuses comprising connectors. Hence, when inspecting an apparatus other than a battery, each time an inspection is ended, the connector must be pulled out manually.

### DISCLOSURE OF INVENTION

The present invention has been made in view of the above problems, and has as its object to provide a pull-out device which facilitates the operation of pulling out a connector from an apparatus to which the connector is inserted, thereby preventing the connector or the like from being broken upon pulling it out.

According to the present invention, there is provided a pull-out device for pulling out a connector from an apparatus to which the connector is connected, comprising a pulling member having one end attached to the connector and the other end to a locking portion, a locking unit arranged to face the connector and to which the locking portion is locked, and a moving unit arranged to move the locking unit and the apparatus relative to each other so as to separate from each other in a pull-out direction of the connector, thereby causing the pulling member to generate tension that pulls out the connector, wherein the locking unit locks with the locking portion such that, as the tension is generated, the locking portion is freely movable within a plane substantially perpendicular to the pull-out direction.

In this pull-out device, the locking portion is locked to be freely movable within the plane almost perpendicular to the pull-out direction of the connector. As the moving unit causes the pulling member to generate tension, the locking portion moves within the plane toward a position where the longitudinal direction of the pulling member coincides with the pull-out direction of the connector. Therefore, if the moving unit continues to move, the connector can be pulled out without applying an excessive force to it. Thus, when pulling out the connector, the connector or the like can be prevented from being broken. As the pull-out operation is automated by the moving unit, the user needs only to lock the locking portion. This facilitates the pull-out operation of the connector.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate an embodiment of the present invention and, together with the description, serve to explain the principle of the invention.

FIG. 1 is a front view of a pull-out device A according to an embodiment of the present invention;

FIG. 2 is a plan view of the pull-out device A according to the embodiment of the present invention;

FIG. 3 is a sectional view taken along the line XX of FIG. 1;

FIG. 4A is a view showing the outer appearance of a pulling member 10;

FIG. 4B is a view showing the outer appearance of a locking member 21;

FIG. 5 is a sectional view showing the main parts at the upper and lower ends of the locking member 21;

FIG. 6 is a view for explaining the operation of the pull-out device A;

FIG. 7 is a view for explaining the operation of the pull-out device A;

FIG. 8 is a view for explaining the operation of the pull-out device A;

FIG. 9 is a view for explaining the operation of the pull-out device A;

FIG. 10 is a front view of a test warehouse B to which the present invention is applied; and

FIG. 11 is a view (side view) for explaining the operation of the test warehouse B.

### BEST MODE FOR CARRYING OUT THE INVENTION

An embodiment of the present invention will be described in detail with reference to the accompanying drawings. Note that the constituent elements described in the embodiment are merely examples, and the scope of the present invention is not limited to them.

### First Embodiment

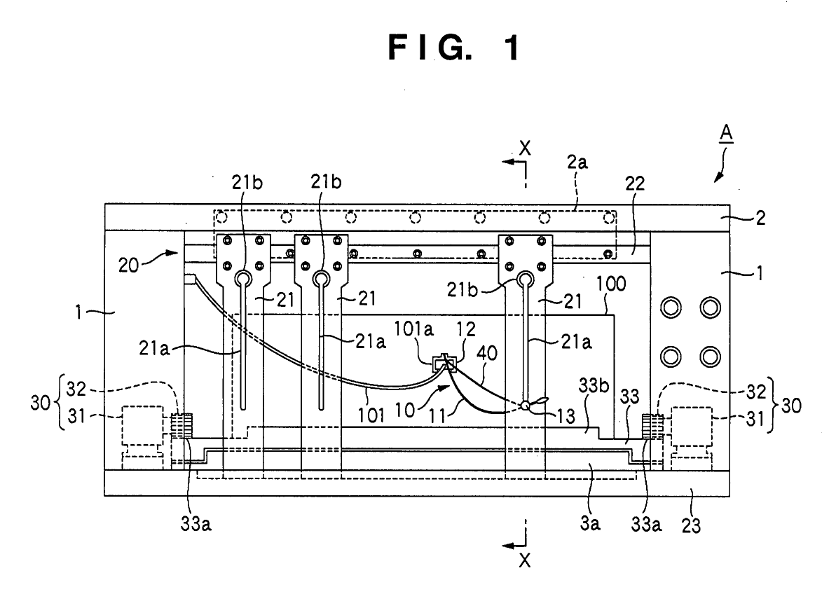

FIG. 1 is a front view of a pull-out device A according to an embodiment of the present invention,

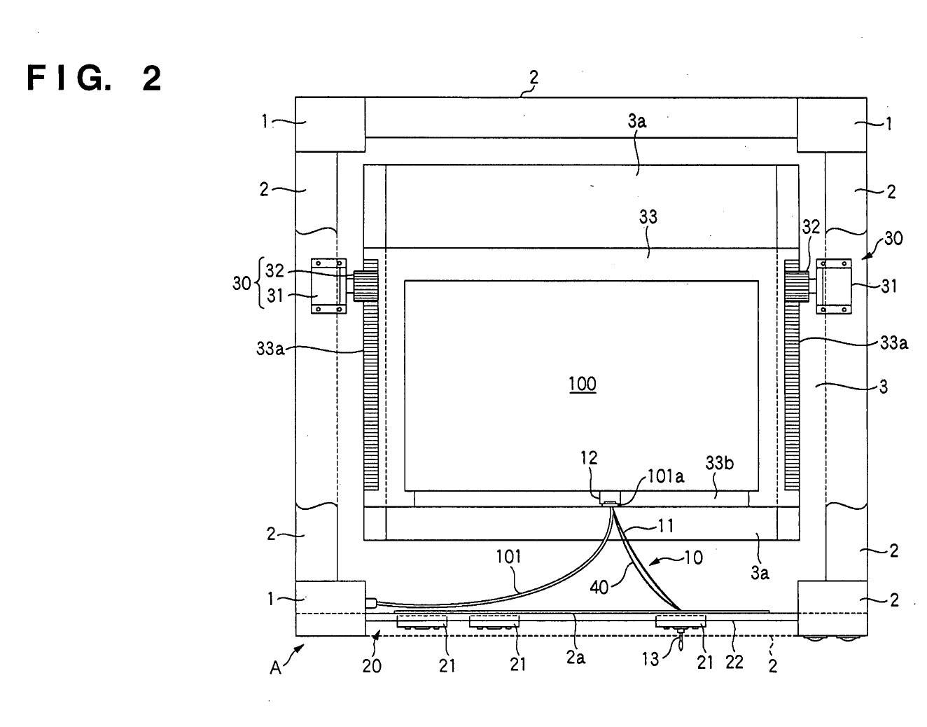

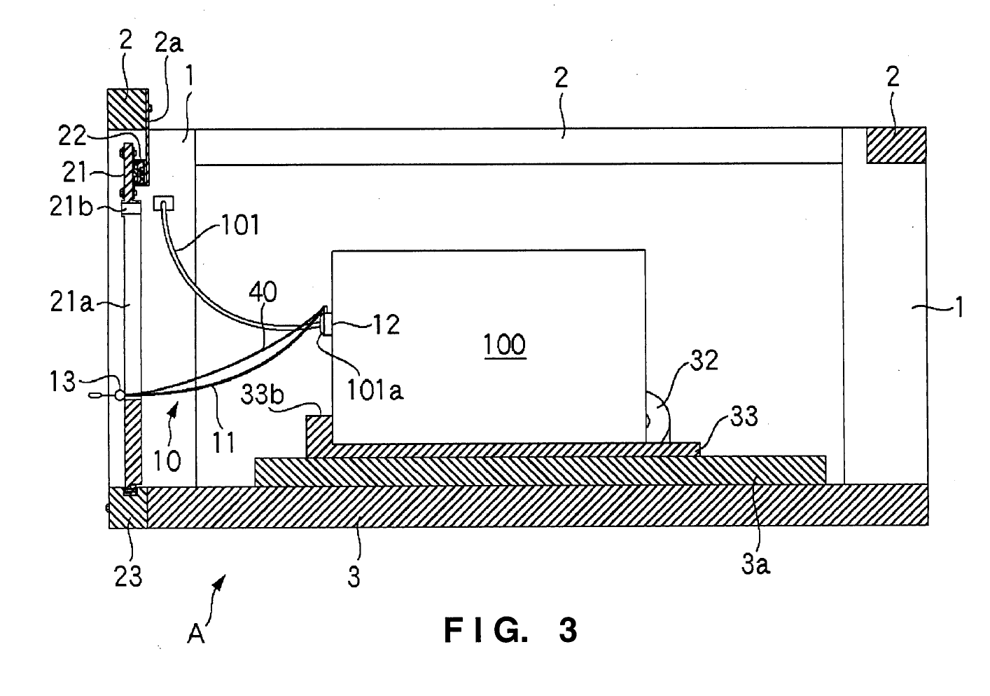

FIG. 2 is a plan view (partially sectional perspective view) of the pull-out device A, and FIG. 3 is a sectional view taken along the line XX of FIG. 1. The pull-out device A is a device which automatically pulls out a connector 101a, connected to an apparatus 100 such as an electrical appliance represented by a television, video deck, or personal computer, from the apparatus 100. According to this embodiment, the connector 101a is a cable which is formed at one end of a power cable 101 of the apparatus 100 and connects the power cable 101 to the apparatus 100. The other end of the power cable 101 is connected to the pull-out device A so that power is supplied to the apparatus 100 during testing. In the case of this embodiment, the connector 101a is pulled out from and inserted into the rear surface (front surface in FIG. 1) of the apparatus 100 almost horizontally.

The pull-out device A comprises a plurality of columns 1, beams 2, and a plate-like bottom 3 to form a frame, and includes a pulling member 10, locking unit 20, and moving unit 30. The columns 1 incorporate a power supply for supplying power to the apparatus 100, facilities for testing the apparatus 100, and the like.

<Pulling Member>

The pulling member 10 comprises a wire 11 represented by a linear steel stock such as a wire, an attaching portion 12 provided to one end of the wire 11 and serving to attach the pulling member 10 to the connector 101a, and a locking portion 13 provided to the other end of the wire 11. In this embodiment, the locking portion 13 is spherical. This embodiment also comprises a linear elastic member 40 which connects the connector 101a to the locking portion 13. The elastic member 40 is an elastic wire of rubber or the like. One end of the elastic member 40 is attached to the locking portion 13, and its other end is attached to the connector 101a through the attaching portion 12. The natural length of the elastic member 40 is set shorter than that of the wire 11.

<Locking Unit>

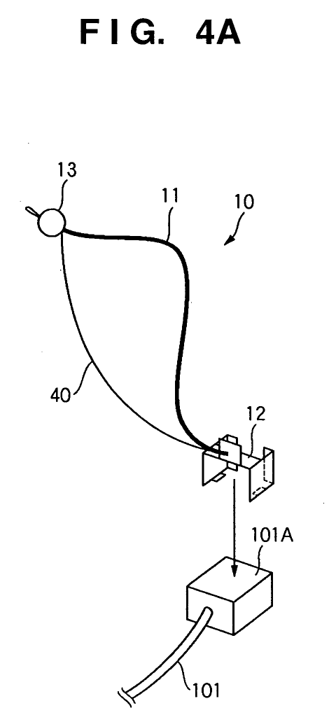

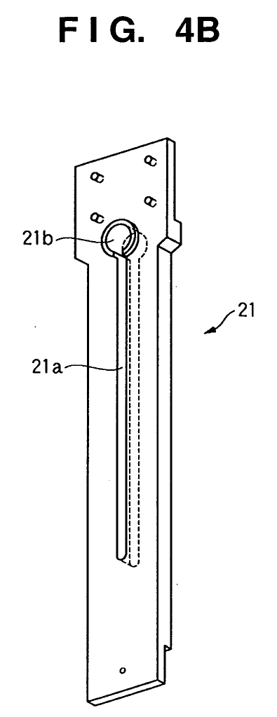

Referring back to FIGS. 1 and 2, the locking unit 20 comprises locking members 21 and guide members 22 and 23, and is arranged to oppose the connector 101a. Each locking member 21 is formed of a plate-like member extending in an almost vertical direction, and has a slit 21a to lock with the locking portion 13 of the pulling member 10. A hole 21b wider than the slit 21a is formed at the upper end of the slit 21a. FIG. 4B is a view showing the outer appearance of the locking member 21. The locking portion 13 has such a size that it does not pass through the slit 21a but can be inserted into the hole 21b. The wire 11 has a diameter such that it passes through the slit 21a. The pulling member 10 is disposed by guiding the locking portion 13 from the rear side to the front side of the locking member 21 through the hole 21b such that the wire 11 passes through the slit 21a. As the locking portion 13 cannot pass through the slit 21a, when pulling the wire 11 to the rear side of the pull-out device A, the locking portion 13 is locked by the locking member 21. The locking portion 13 is guided by the slit 21a to be freely movable along the slit 21a. The locking portion 13 can adopt an arbitrary shape. If the locking portion 13 is spherical as in this embodiment, the contact area of the locking portion 13 with the surface of the locking members 21 decreases. Then, the locking portion 13 can be freely moved more smoothly along the slit 21a.

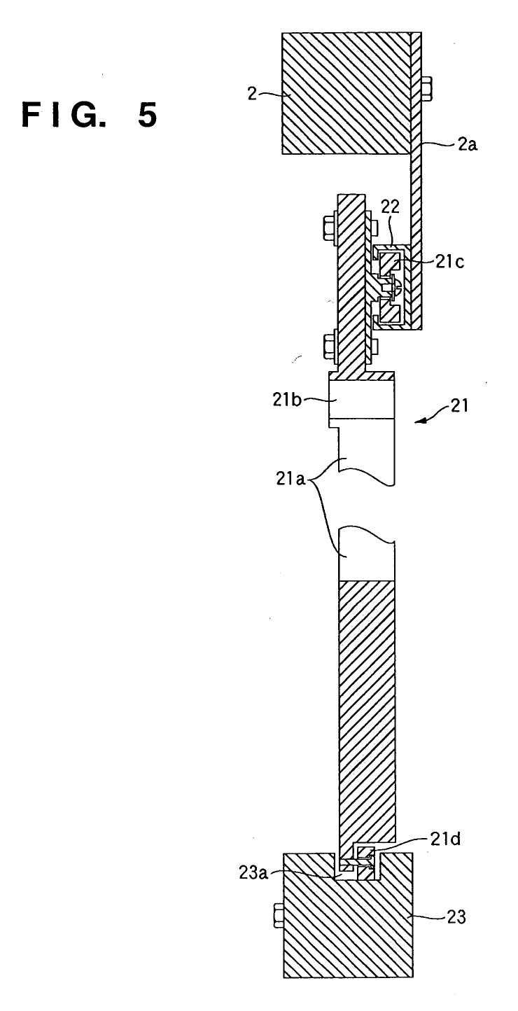

The guide member 22 is supported almost horizontally between the left and right columns 1 on the front surface, and is supported by a support plate 2a attached to the front beam 2. The guide member 23 is provided to the front end on the front side of the bottom 3. The guide members 22 and 23 respectively support the upper and lower ends of the locking member 21, and guide the locking member 21 to move freely in the almost horizontal direction (the left-to-right direction when seen from the front surface of the pull-out device A). FIG. 5 is a sectional view showing the main parts at the upper and lower ends of the locking member 21.

The guide member 22 is a rail member having an almost U-shaped section. A roller 21c rotatably arranged on the rear surface of the upper portion of the locking member 21 smoothly moves in the guide member 22. The guide member 23 has in its upper surface a rail-shaped recess 23a extending in an almost horizontal direction. A roller 21d rotatably arranged at the lower end of the guide member 23 smoothly moves in the recess 23a.

With this arrangement, the locking member 21 can freely move in an almost horizontal direction as its upper and lower portions are supported by the guide members 22 and 23. As described above, the locking portion 13 can move in an almost vertical direction along the slit 21a of the locking member 21. The moving direction of the locking member 21 is perpendicular to the moving direction of the locking portion 13. Accordingly, the locking portion 13 can move to an arbitrary position in a plane (to be referred to as a locking plane hereinafter) in the almost vertical direction which is defined by the locking member 21 and the guide members 22 and 23.

In this embodiment, the moving direction of the locking portion 13 with respect to the locking member 21 is determined as the almost vertical direction, and the moving direction of the locking member 21 guided by the guide members 22 and 23 is determined as the almost horizontal direction. An arbitrary direction can be selected under the condition that the moving direction of the locking portion 13 is perpendicular to that of the locking member 21.

In this embodiment, one set of guide members 22 and 23 guide free movement of the plurality of (three) locking members 21. This embodiment assumes the case of pulling out one connector 101a of the apparatus 100. If the apparatus 100 is provided with a plurality of connectors, pulling members 10 may be assigned to the respective locking member 21 and the respective connectors, so the plurality of connectors can be pulled out simultaneously.

In this embodiment, one locking member 21 locks with one pulling member 10. Alternatively, one locking member 21 can lock with a plurality of pulling members 10. This is effective, in a case in which the apparatus 100 is provided with a plurality of connectors in the vertical direction, when pulling out the plurality of connectors simultaneously by one locking member and a plurality of pulling members 10 corresponding in number to the connectors.

<Moving Unit>

Referring to FIGS. 1 to 3, the moving unit 30 is a driving unit comprising a pair of motors 31 arranged on the bottom 3 and pinions 32 attached to the output shafts of the motors 31, and driven by a controller (not shown). The pinions 32 mesh with racks 33a formed on the two sides of a support table 33, thereby moving the support table 33. The support table 33 supports the apparatus 100. A guide portion 33b projecting upward to abut against the rear surface (the front surface in FIG. 1) of the apparatus 100 is provided to the front edge of the support table 33.

The support table 33 is mounted on a guide table 3a fixed on the bottom 3, and can move in a pull-out direction (a direction perpendicular to the locking plane) of the connector when the connector is pulled out by the pull-out device A. According to this embodiment, the support table 33 can reciprocate almost horizontally in the direction of depth of the pull-out device A. The racks 33a are arranged in the direction of depth of the pull-out device A. When the motors 31 rotate the pinions 32, the support table 33a moves almost horizontally in the direction of depth of the pull-out device A. When the operation of the moving unit 30 moves the support table 33 in the direction of depth of the pull-out device A, the locking unit 20 and apparatus 100 can be moved relative to each other to separate from each other in the pull-out direction of the connector 101a.

<Pull-Out Operation>

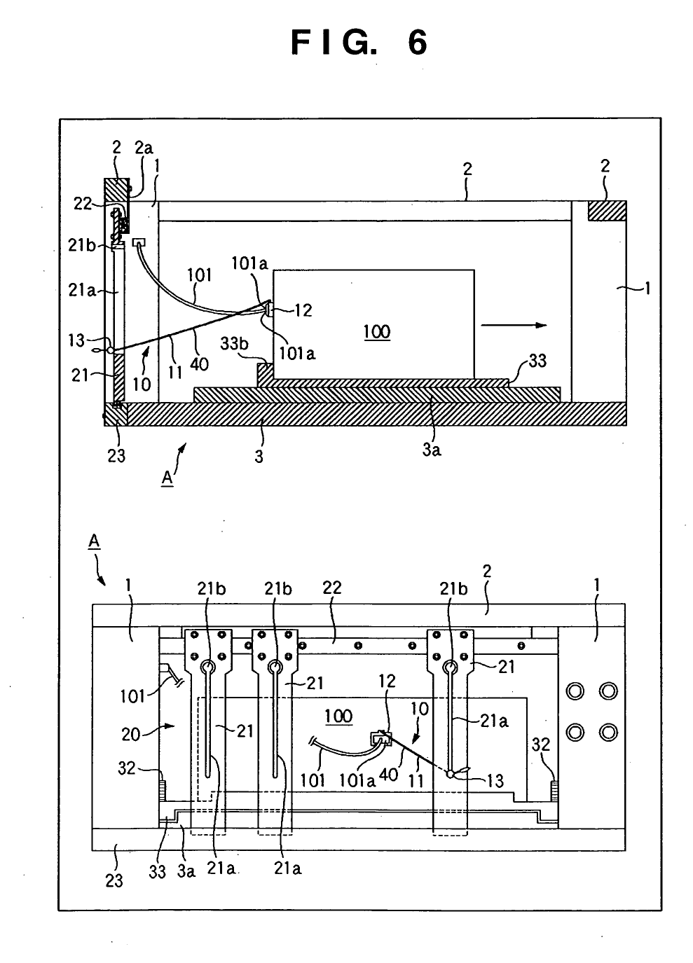

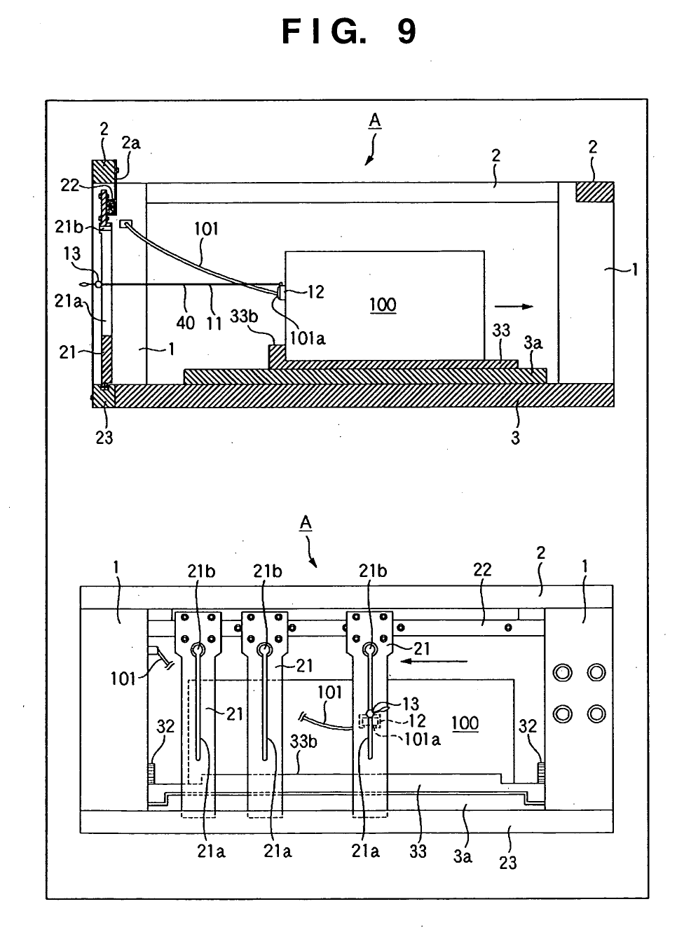

The pull-out operation of the connector 101a by the pull-out device A will be described. FIGS. 6 to 9 are views for explaining the operation of the pull-out device A, in each of which the upper part shows a side view (sectional view) and the lower part shows a front view. First, the operator guides the locking portion 13 of the pulling member 10 from the rear side to the front side of the locking member 21 through the hole 21b, and sets the pulling member 10 such that the wire 11 passes through the slit 21a. This operation may be performed after or before testing the pulling member 10. Then, the moving unit 30 is operated to move the support table 33 to the deep end side of the pull-out device A.

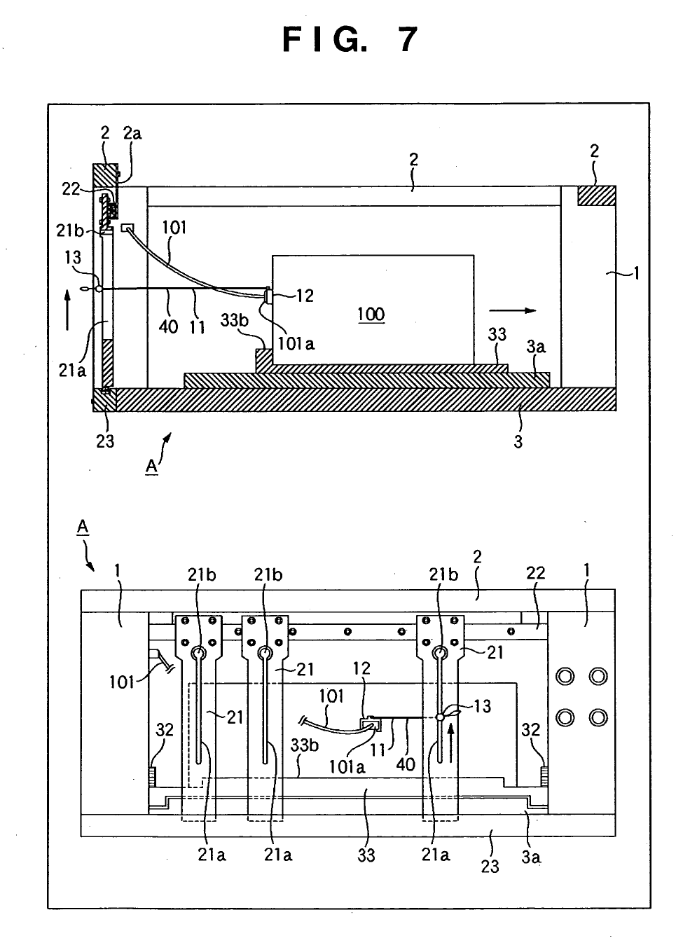

Then, the locking unit 20 and apparatus 100 separate from each other, and the pulling member 10 starts to become taut with no slack, as shown in FIG. 6, thereby generating tension. As the natural length of the elastic member 40 is set to be shorter than that of the wire 11, in the state of FIG. 6, the elastic member 40 has already stretched to exhibit its elastic force. When the movement of the support table 33 progresses and the separation distance between the locking unit 20 and apparatus 100 further increases, as the length of the wire 11 does not change, the locking portion 13 of the pulling member 10 freely moves along the slit 21a of the locking member 21. Then, as shown in FIG. 7, the locking portion 13 is positioned on almost the same horizontal plane as the connector 101a.

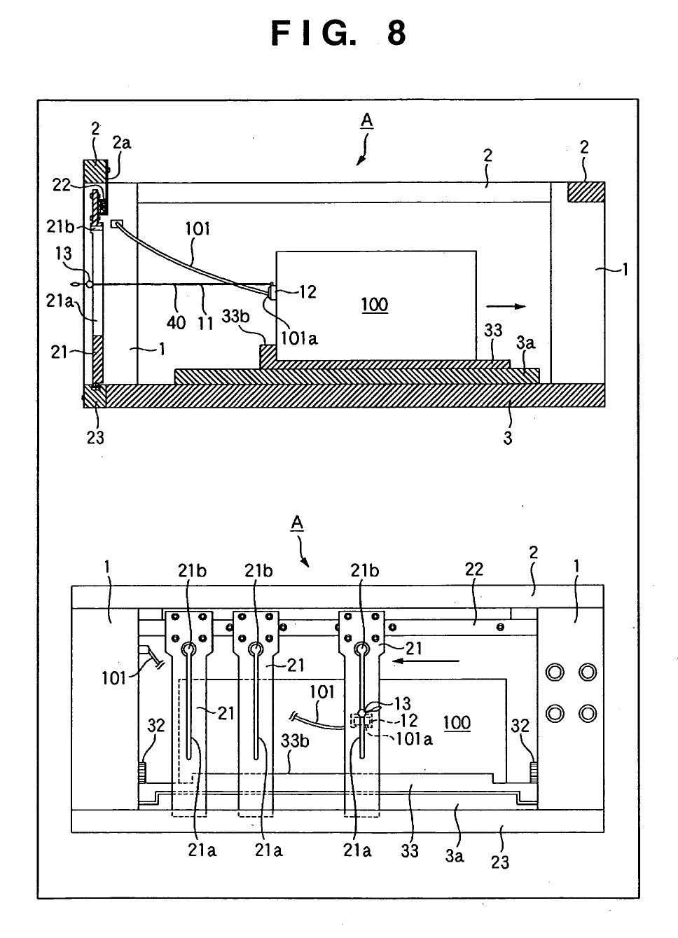

When the movement of the support table 33 progresses and the separation distance between the locking unit 20 and apparatus 100 further increases, the locking member 21 moves along the guide members 22 and 23, and the locking portion 13 of the pulling member 10 is positioned on almost the same vertical plane as the connector 101a. Although free movement of the locking portion 13 along the slit 21a of the locking member 21 (FIG. 7) and movement of the locking member 21 along the guide members 22 and 23 (FIG. 8) are described separately for the descriptive convenience, these two movements can occur simultaneously.

When movement of the support table 33 further progresses and the separation distance between the locking unit 20 and apparatus 100 further increases, the tension of the pulling member 10 pulls out the connector 101a. When the connector 101a is pulled out, the elastic member 40 is restored to the natural state by its restoration force. Upon pulling out the connector 101a, it drops to under the forward portion of the pull-out device A without springing up in an unintended direction. Thus, the pull-out operation is ended.

<Effect of Pull-Out Device A>

In the pull-out device A, the locking portion 13 is locked to be freely movable within the locking plane almost perpendicular to the pull-out direction of the connector 101a. When the moving unit 30 moves the support table 33 in the direction of depth of the pull-out device A to separate the locking unit 20 and apparatus 100 from each other, as the pulling member 10 generates tension, the locking portion 13 moves within the locking plane toward a position where the longitudinal direction of the pulling member 10 coincides with the pull-out direction of the connector 101a. Namely, the pull-out force of the pulling member 10 acting on the connector 101a does act in the pull-out direction of the connector 101a. The connector 101a can thus be pulled out without applying an excessive force to it.

Therefore, when pulling out the connector 101a, the connector 101a and the like can be prevented from being broken. As the pull-out operation is automated, the user only needs to lock the locking portion 13 with the locking unit 20. This facilitates the pull-out operation of the connector 101a. In particular, according to this embodiment, the locking portion 13 needs only to be inserted into the hole 21b from the rear side of the locking member 21, making the locking operation very easy.

The plurality of locking members 21 are provided. Which locking member 21 is to lock the pulling member 10 can be selected appropriately, and the locking portion 13 of the pulling member 10 can be engaged with and disengaged from the locking member 21 by only inserting or removing it in or from the hole 21b. For example, even if the type of the apparatus 100 to be tested is changed and the position of the connector 101a is changed, the change in the type of the apparatus 100 can be easily coped with by selecting the locking member 21 which is the closest to the connector 101a and locking the pulling member 10 by the locking member 21.

According to this embodiment, the apparatus 100 is moved with respect to the locking unit 20. As far as the locking unit 20 and apparatus 100 can be moved relative to each other such that they separate from each other in the pull-out direction of the connector 101a, the locking unit 20 may be moved, or both the locking unit 20 and apparatus 100 may be moved.

### Second Embodiment

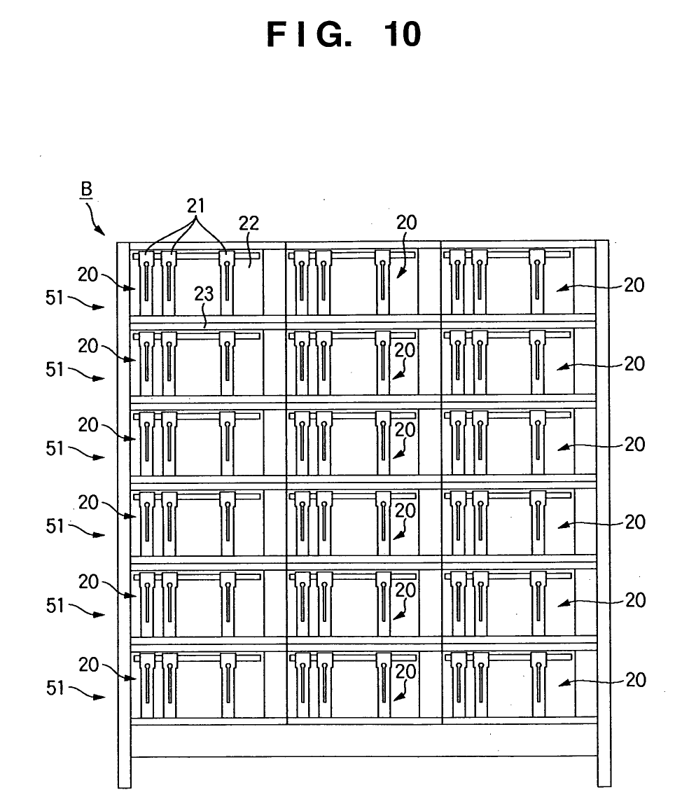

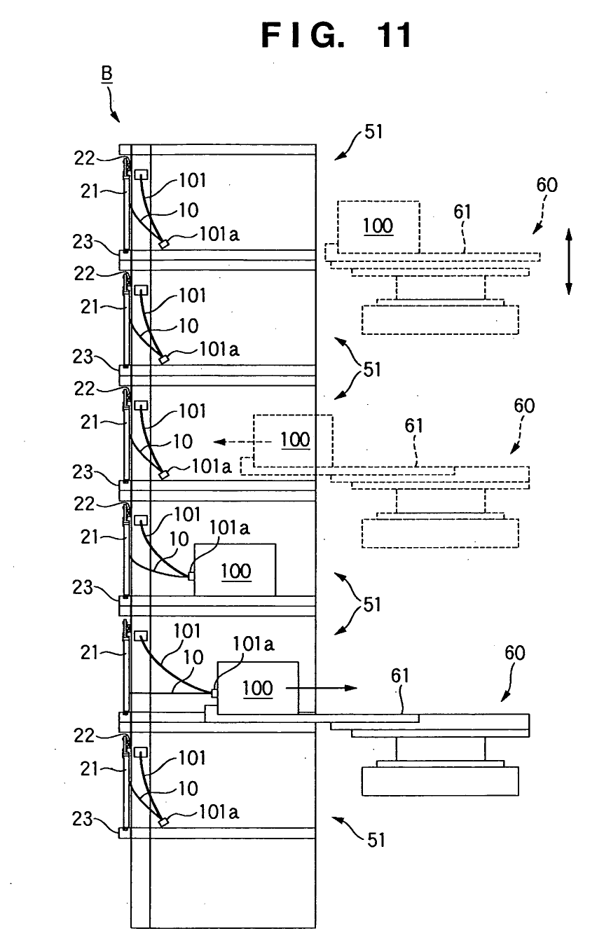

FIG. 10 is a front view of a test warehouse B to which the present invention is applied, and FIG. 11 is a view (side view) for explaining the operation of the test warehouse B. The test warehouse B is where a plurality of apparatuses 100 are to be tested and stored. The test warehouse B has a frame body including a plurality of levels of (five levels in this case) racks 51 in the vertical direction. A plurality of testing/storing areas (three in this case) for the apparatuses 100 are set on each rack 51 in the horizontal direction. A locking unit 20 identical to that described above is disposed on the front side of each testing/storing area.

As shown in FIG. 11, a transfer robot 60 which transfers the apparatus 100 is disposed on the rear side of the test warehouse B. The transfer robot 60 can be arbitrarily moved by a device (not shown) vertically and horizontally and can access each testing/storing area from the rear side. The transfer robot 60 comprises a movable arm 61 which can move in the direction of depth of each testing/storing area. The apparatus 100 is moved as it is placed on the movable arm 61.

The transfer robot 60 transfers an apparatus 100 as the test target to an empty testing/storing area. In the testing/storing area, a pulling member 10 is attached between a connector 101a for the apparatus 100 and a locking member 21 of the locking unit 20 corresponding to this testing/storing area. When the test is ended and the connector 101a is to be pulled out, the movable arm 61 performs a function corresponding to the support table 33 described above. More specifically, first, the transfer robot 60 moves to the testing/storing area of the tested apparatus 100. The transfer robot 60 inserts the movable arm 61 to under the apparatus 100 so the apparatus 100 is placed on the movable arm 61. Then, the transfer robot 60 moves the apparatus 100 in the direction of depth of the testing/storing area. This pulls out the connector 101a from the apparatus 100. After that, the transfer robot 60 transfers the apparatus 100 to a location specified in advance.

The present invention is not limited to the above embodiment and various changes and modifications can be made within the spirit and scope of the present invention. Therefore, to apprise the public of the scope of the present invention, the following claims are made.

1. A pull-out device for pulling out a connector from an apparatus to which said connector is connected, comprising:
a pulling member having one end attached to said connector and the other end with a locking portion;
a locking unit arranged to face said connector and to which said locking portion is locked; and
a moving unit arranged to move said locking unit and the apparatus relative to each other so as to separate from each other in a pull-out direction of said connector, thereby causing said pulling member to generate tension that pulls out said connector,
wherein said locking unit locks with said locking portion such that, as the tension is generated, said locking portion is freely movable within a plane substantially perpendicular to the pull-out direction.

2. The pull-out device according to claim 1, wherein said locking unit includes
a locking member which guides free movement of said locking portion in a first direction within the plane, and
a guide member which guides free movement of said locking member so that said locking member is freely movable in a second direction within the plane perpendicular to the first direction.

3. The pull-out device according to claim 2, further comprising a support member which supports the apparatus such that the pull-out direction is substantially horizontal,
wherein said moving unit moves said locking unit and said support member relative to each other so as to separate from each other in the pull-out direction, and
one of the first direction and the second direction comprises a substantially horizontal direction and the remaining one thereof comprises a substantially vertical direction.

4. The pull-out device according to claim 2, wherein said locking member includes
a slit in which said pulling member can be inserted and which extends in the first direction, and
a hole formed at an end of the slit and wider than said slit,
wherein said locking portion is set at such a size that said locking portion is not inserted in the slit but is capable of being inserted in the hole.

5. The pull-out device according to claim 4, wherein said locking portion comprises a spherical body.

6. The pull-out device according to claim 2, wherein said guide member guides free movement of a plurality of locking members.

7. The pull-out device according to claim 2, wherein said locking member locks said locking portion of each of said plurality of pulling members.

8. The pull-out device according to claim 1, further comprising an elastic member which connects said connector and said locking portion to each other.
